(19) United States
(12) Patent Application Publication
(10) Pub. No.: US 2015/0090519 A1
(43) Pub. Date: Apr. 2, 2015

(54) SEMI-DECOUPLED STEERING SYSTEM

(71) Applicant: Ford Global Technologies, LLC, Dearborn, MI (US)

(72) Inventor: Anthony Mario D'Amato, Canton, MI (US)

(73) Assignee: Ford Global Technologies, LLC, Dearborn, MI (US)

(21) Appl. No.: 14/041,086

(22) Filed: Sep. 30, 2013

(51) Int. Cl. F16D 3/10; B62D 7/22; B62D 5/04

(52) U.S. Cl. CPC F16D 3/10; B62D 5/0463; B62D 7/224; B62D 5/0409
USPC 180/446; 464/137

(57) ABSTRACT

A steering system for a vehicle is disclosed. The steering system may have a steering linkage and a controller. When operation of the steering system is within a predefined relative rotational range, the controller may be programmed to translate steering motion to a steering gear box through a motor. Operation of the steering system outside the predefined rotational limit actuates the steering linkage. Once the steering linkage is actuated, steering motion is translated to the steering gear box directly through the steering linkage.

### TECHNICAL FIELD

This disclosure relates to steering systems for a vehicle and specifically to steering systems with a decouplable steering mechanism.

### BACKGROUND

Steering systems in vehicles may use a variety of shafts, gears, cables, and pulleys to transfer a steering input from a steering mechanism such as a steering wheel, yoke, stick, steering pedal, or tiller to a control component such as road wheels, ailerons, rudders, or other control surfaces, which may then steer the vehicle. Steering systems may incorporate systems which provide a mechanical advantage or power assistance between the steering mechanism and the control component. In automobiles, a gearbox may be used to transfer the rotational input of a steering wheel to road wheels and to provide a mechanical advantage, power assistance, and even variable ratio steering.

Common gearboxes used in automobiles include a rack and pinion, a recirculating ball, or a worm and sector mechanism to transfer the rotational movement of the steering wheel to the pivotal movement of the road wheels. Power steering systems help drivers steer vehicles by augmenting steering effort of the steering wheel. Hydraulic or electric actuators may add controlled energy to the steering mechanism, so the driver needs to provide only modest effort regardless of conditions. The actuators are often connected to the steering system through additional sets of gearing. A direct mechanical connection between the steering mechanism and the control component may provide a path for noise, vibration, and harshness to pass.

Steer-by-wire systems decouple the direct mechanical connection between the steering mechanism and the control component and replace the traditional mechanical control systems with electronic control systems. Safety can be improved by providing computer controlled intervention of steering with systems such as Electronic Stability Control (ESC), adaptive cruise control and Lane Assist Systems. Ergonomics can be improved by the amount of force and range of movement required by the driver and by greater flexibility in the location of controls. This flexibility also significantly expands the number of options for the vehicle's design.

To provide for a redundant back-up system in steer-by-wire systems, a backup clutch may be used. Clutches used in steer-by-wire systems are normally closed requiring power to be applied to disengage the clutch while in use. A clutch is a mechanical device that provides for the transmission of motion from one component (the driving member) to another (the driven member) when engaged, and allows for complete disengagement from one component to another when not engaged.

### SUMMARY

In one aspect of the disclosure, a vehicular steering linkage is provided. The linkage has a first steering shaft with a first interaction surface, and a second steering shaft with a second interaction surface. The first and the second steering shafts rotate independently of each other within a predetermined relative rotational range provided between the two interaction surfaces of the shafts. Operation within the predetermined relative rotational range allows the steering linkage to decouple components within a vehicle steering system. The steering system may include a steering wheel and a steering gearbox. When the vehicle steering system is operated within the predetermined relative rotational range the steering linkage decouples the steering wheel and steering gearbox. When the predetermined relative rotational range is met, the interaction surfaces contact each other and couples the steering wheel and steering gearbox.

In another aspect of the disclosure, a steer-by-wire system is provided. The steering control system may include a controller and a steering linkage. The controller monitors the motion of a steering wheel and translates that motion to a steering gear box. The controller actuates a motor to assist in translating the motion of the steering wheel to the steering gear box. The motor may be an electric power assist motor. The controller may also be in communication with a steering wheel movement motor. Utilizing the steering wheel movement motor, the controller may be programmable to align steering wheel movement with steering gearbox movement resulting from a vehicle wheel movement.

A steering linkage is disposed between two steering shafts. The steering linkage may have a relative steering angle range within which the steering linkage provides decoupled rotation of the two steering shafts. The steering linkage further provides a relative rotational limit at which the steering linkage provides coupled rotation of the two steering shafts. Coupling the steering shafts translates the motion of a steering wheel directly to a steering gear box. This allows for a direct mechanical link from the steering wheel to the steering gear box.

In yet another aspect of the disclosure, a semi-decoupled steering system is provided. The semi-decoupled system includes a controller and a passive mechanical linkage. The controller may be programmable to monitor and align movement of a steering mechanism and a steering gearbox to provide a steer-by-wire effect. The passive mechanical linkage is disposed between the steering mechanism and the steering gear box and may provide a direct mechanical engagement from the steering mechanism to the steering gear box when a misalignment limit is met.

The steering system may further include a first steering shaft in coupled movement with the steering mechanism and a second steering shaft in coupled movement with the steering gearbox. The steering shafts may define the relative rotational range comprising the misalignment limit. The passive mechanical linkage couples the steering shafts at a rotational limit within the relative rotational range. For example, the relative rotational range comprising the misalignment limit may have a positive rotational direction limit and a negative rotational direction limit. When operating between the positive and negative rotational direction limits the first and second steering shafts are rotationally disengaged, and only engage when either the positive or negative rotational direction limits are met.

Embodiments according to the present disclosure provide a number of advantages. For example, the present steering linkage does not require power to remain decoupled and a predetermined rotational limit may also provide a backup in case of power steering lag. These embodiments are meant to be merely illustrative and not conclusive.

### BRIEF DESCRIPTION OF THE DRAWINGS

FIG. 1 is a diagrammatic view of a semi-decoupled vehicle steering system.

FIG. 2 is an exploded diagrammatic view of a steering linkage.

FIG. 3 is an exploded diagrammatic view of an alternate embodiment of a steering linkage.

FIG. 4 is a flow chart of a steering operation embodiment using a semi-decoupled vehicle steering system.

### DETAILED DESCRIPTION

The illustrated embodiments are disclosed with reference to the drawings. It should be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but merely as a representative basis for teaching one skilled in the art how to practice the disclosed concepts.

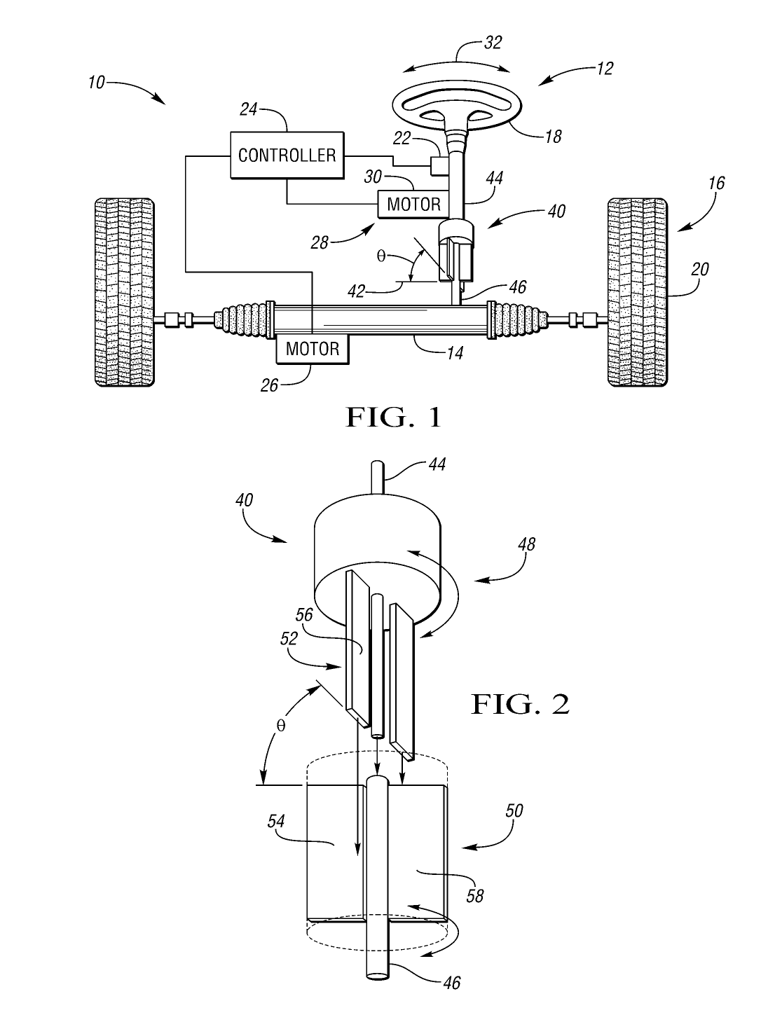

Referring to FIG. 1, a vehicle steering system 10 is provided with a steering mechanism 12 capable of receiving a steering input from a user and a steering gear box 14 capable of providing a steering output to a control component (not shown). The steering mechanism 12 may be a steering wheel 18, as shown here, or any other device capable of receiving steering input from a user, such as, but not limited to, a yoke, steering pedal, stick, or tiller. The control component may be a wheel and tire 20, as shown here, or any other device capable of steering a vehicle, such as, but not limited to, ailerons, rudders, skis, tracks, or other control surfaces.

In the case where the steering mechanism 12 is a steering wheel 18, the system may have a steering angle sensor 22 connected to it to measure the rotational/angular movement of the steering mechanism 12. A controller 24 may be in communication with the steering angle sensor 22, and the steering angle sensor 22 may transmit the motion of the steering wheel 18 to the controller 24. The controller 24 may then be programmed to actuate a motor 26 to translate the steering wheel 18 angular movements to the gearbox 14. The motor 26 is configured to be actuated by the controller 24 to align movement of the steering gearbox 14 with a steering mechanism 12, in this case a steering wheel 18. In essence, the motor 26 translates steering wheel 18 angular movement to the steering gearbox 14. The motor 26 may be an electric power assist motor.

Further, a second motor 28, different from motor 26, may be disposed on the steering mechanism 12. The steering mechanism motor 28 may be in communication with the controller 24, and the controller 24 may be further programmed to align steering mechanism 12 movement with the steering gearbox 14 movement. The controller 24 may be programmed to align steering gearbox 14 movements with steering mechanism 12 movements in both directions using both motors 26, 28 simultaneously. The controller 24 may be further programmed to filter out noise, vibration, and harshness from the gearbox 14 and vehicle wheel 20 from being transmitted to the steering mechanism 12. The steering mechanism motor 28 may be a steering wheel movement motor 30.

For example, as the vehicle is being driven, a driver may turn the steering wheel 18, as shown by arrow 32, and the controller 24 would respond by energizing both motors 26, 30 simultaneously. The controller 24 would energize motor 26 to move the steering gearbox 14 an appropriate distance to align with the angular rotation of the steering wheel 18, while at the same time providing feedback resistance to the turning of the vehicle back to the driver through motor 30. As the vehicle comes out of the turn, the driver may allow the steering wheel 18 to slip within their hands, moved by motor 30, the controller recognizing the slip and responding by controlling each motor 26, 30 as necessary to allow for the front wheels 20 to straighten back out. The controller 24, in combination with at least the two motors 26, 30, and an array of sensors (not all shown, one of which being the steering angle sensor 22), may provide the same level of input and response found in a traditional steering system. The concept of using a controller 24 to transfer rotational movement of a steering wheel 18 electronically via motors to steerable wheels and tires 20 is referred to as a steer-by-wire system.

The controller 24 may also be programmed to provide variable ratio steering with traditional gearboxes 14 by providing greater gearbox 14 translation as compared to steering mechanism 12 input at differing points in the motion of the steering mechanism 12. Steer-by-wire systems require power to operate, as such it may be advantageous to provide a backup or redundant system in the case of power loss.

A steering linkage 40, which may be a passive mechanical linkage, is disposed between the steering mechanism 12 and the steering gearbox 14. The steering linkage 40 is configured to allow the steering mechanism 12 and the steering gearbox 14 move independently of each other within a predetermined alignment range, shown here as a predetermined relative rotational range θ. The steering linkage 40 provides a direct mechanical link between the steering mechanism 12 and the steering gearbox 14 when a predetermined misalignment limit 42, shown here as a rotational limit 42, of the two is met. When the predetermined misalignment limit 42 is met, the steering linkage 40 engages and translates the steering movement 32 of the steering mechanism 12 to the steering gearbox 14.

Steering linkage 40 may be disposed between a first steering shaft 44 and a second steering shaft 46. Alternatively, the steering linkage may include the first and second steering shafts 44, 46. The steering linkage 40 provides decoupled rotation of the two shafts 44, 46 within a relative rotational range θ and coupled rotation of the two shafts at a relative rotational limit 42. The first shaft 44 may be an input shaft 44 in coupled movement with the steering mechanism 12, and the second shaft 46 may be an output shaft 46 in coupled movement with the steering gearbox 14. The steering linkage 40 provides for a specified relative interaction between the first and second shafts 44, 46.

The interaction between the first shaft 44 and the second shaft 46 allows is decoupled within the predefined rotational range θ. The steering linkage 16 interacts with the two shafts 44, 46 and is capable of coupling the two shafts 44, 46 at a rotational limit 42 at one end of the relative rotational range θ. The predetermined rotational range θ typically does not exceed 15 degrees, but may be in the range of 1 to 5 degrees.

Referring to FIG. 2, a diagrammatic exploded example of the steering linkage 40 of FIG. 1 is shown. In this figure, the steering linkage 40 is shown with a first portion 48 pulled away from a second portion 50 illustrating that the steering linkage 40 decouples a direct connection between the first and second shafts 44, 46. As before, the first shaft 44 is in a coupled rotational movement with the steering mechanism 12 and the second shaft 46 is in coupled rotational movement with the steering gearbox 14 (see FIG. 1). As the steering mechanism 12 moves, the first portion 48 moves, and as the steering gearbox 14 moves, the second portion 50 moves. So long as the movement between the steering mechanism 12 and the steering gearbox 14 remains aligned, the first and second portions 48, 50, and thus the first and second shafts 44, 46, move in unison.

Any misalignment in the movement of the steering mechanism 12 and steering gearbox 14 may occur within the predetermined relative rotational range θ of the first and second shafts 44, 46. The predetermined rotational range θ may be defined by a first interaction surface 52 on the first portion 48 of the steering linkage 40 and a second interaction surface 54 on the second portion 50 of the steering linkage 40. When the relative rotation of the first and second shafts 44, 46 meets the predetermined relative rotational range θ, the first interaction surface 52 contacts the second interaction surface 54 causing a direct linkage between the two shafts 44, 46. Contact between the first and second interaction surfaces 52, 54 causes the first steering shaft 44 and the second steering shaft 46 to rotate jointly, or as one linkage. The occurrence of a misalignment meeting the predetermined relative rotational range θ such that the first interaction surface 52 contacts the second interaction surface 54 may also be understood as a positive relative rotational limit.

The steering linkage 40 may also include a third interaction surface 56 and a fourth interaction surface 58. As with contact between the first and second interaction surfaces 52, 54, contact between the third and fourth interaction surfaces 56, 58 may also cause joint rotation of the first and second steering shafts 44, 46, just in the opposite direction. The occurrence of a misalignment meeting the predetermined relative rotational range θ such that the third interaction surface 56 contacts the fourth interaction surface 58 may be understood as a negative relative rotational limit. The distance between these positive and negative relative rotational limits may be understood as the predetermined relative rotational range θ. For example, with a predetermined rotational range of 15 degrees, the first interaction surface 52 may contact the second interaction surface 54 at a positive relative rotational limit of +7.5 degrees and the third interaction surface 56 may contact the fourth interaction surface 58 at a negative relative rotational limit of −7.5 degrees.

Once either of the positive or negative rotational limits is reached, the predetermined rotational limit θ is met and steering shafts 44, 46 are rotationally engaged. Being rotationally engaged, the first and second steering shafts 44, 46 rotate together until disengagement occurs. The steering shafts 44, 46 may remain rotationally engaged until the relative rotation of the two shafts changes direction to be within the relative rotational range θ again. This causes the two shafts 44, 46 to become disengaged until either the positive rotational direction limit is re-met or the negative rotational direction limit is met in an opposite relative rotational direction of the shafts 44, 46.

When the steering shafts 44, 46 are disengaged, operating within the predetermined relative rotational range θ, noise, vibration, and harshness are inhibited from being transferred from the steering gear box 14, or other steering system components, to the steering mechanism 12. The steering linkage 40 engages and translates the steering movement of the steering mechanism 12 to the gearbox 14 only when either the positive rotational limit or the negative rotational limit is reached. It should be noted that FIG. 2 is diagrammatic in showing a nearly 180 degree predetermined rotational range θ, however, as mentioned above, the predetermined rotational range θ typically does not exceed 15 degrees, and may even be in the range of 1 to 5 degrees. Changing the angular distance between the second interaction surface 54 and fourth interaction surface 58 can accomplish a reduced predetermined rotational range θ.

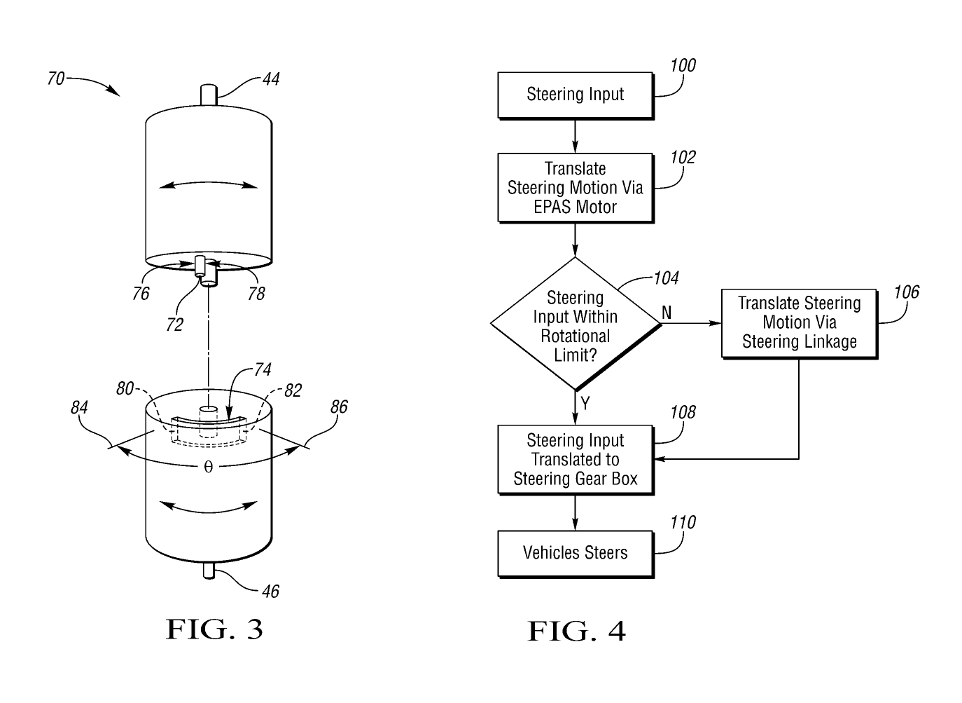

Referring to FIG. 3, an alternate diagrammatic exploded example of a steering linkage 70 is shown disposed between the first and second steering shafts 44, 46. In this example, the relative rotational range θ is provided by a pin 72 disposed in a slot 74. Opposing sides of the pin 72 may provide first and third interaction surfaces 76, 78 and opposing side walls of the slot 74 may provide second and fourth interaction surfaces 80, 82. As before, when the first surface 76 contacts the second surface 80, which may also be referred to as a positive rotational direction limit 84, the two shafts 44, 46 will engage and rotate together. Similarly, when the third surface 78 contacts the fourth surface 82, which may also be referred to as a negative rotational direction limit 86, the two shafts 44, 46 will also engage and rotate together. Relative rotation of the two shafts 44, 46 within the predetermined rotational range θ allows for the two shafts 44, 46 to rotate independently. FIG. 3 clearly shows the rotational distance between the positive and negative rotational limits 84, 86 as being the predetermined rotational range θ, and the range θ may be set by changing the length of the slot 74. As with steering linkage 40, steering linkage 70 may also have a predetermined rotational range θ of 15 degrees or less and may be in the range of 1 to 5 degrees.

Coupled rotation between the first steering shaft 44 and the second steering shaft 46 directly translates the steering mechanism 12 motion to the steering gearbox 14. This is true even if the controller 24 is still communicating movements between the steering mechanism 12 and the steering gearbox 14, thus the steering linkages 40, 70 may provide a backup in case of power loss or in the case of any misalignment between two steering system components. A typical steer-by-wire system merely has a normally open clutch which may only engage in the case of power loss and provides no misalignment protection. The normally open clutch requires power to maintain the clutch open during operation. The steering linkages 40, 70, as disclosed here are passive mechanical linkages requiring no power to function. Even though the steering linkages 40, 70, as described above may replace typical steer-by-wire clutches, it is also envisioned that a control strategy may be employed to monitor the steering components for misalignment and engage a clutch when misalignment exists.

Referring to FIG. 4, an operational flow-chart for a semi-decoupled steering system is provided. At step 100 a steering input is received by the system. At step 102, a controller attempts to translate all of the steering input to a steering gearbox via a motor. At step 104, the semi-decoupled steering system monitors whether the steering input is within a rotational range in relation to the gearbox movement. If the steering input reaches a predetermined rotational limit, defining the boundaries of the rotational range, the steering input is not within the rotational limit and the process moves to step 106.

At step 106, a steering linkage translates the steering input to the steering gear box and the process moves to step 108. This creates a direct mechanical linkage from the steering input to the steering gear box. However, if the steering input is within the predetermined rotational range, such that the controller actuated a motor translating all of the steering input to the steering gear box, maintaining the steering components within alignment, then the process proceeds directly to step 108 without the need to go to step 106. At step 108, all of the steering input from step 100 is translated to the steering gearbox, whether by motor, flowing directly through steps 102, 104 to 108, or through step 106 if the motor is unable to transfer all of the steering input. Once the steering input is translated to the steering gear box, either through a linkage, through a motor, or a combination of the two, the vehicle steers at step 110.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicular steering linkage comprising:
a first steering shaft having a first interaction surface configured to interact with a second steering shaft having a second interaction surface such that the shafts rotate independently from each other within a predetermined relative rotational range and the interaction surfaces contact each other at a predetermined relative rotational limit resulting in joint rotation between the two shafts.

2. The steering linkage of claim 1 wherein the steering linkage hinders noise and vibration of a steering system from being transmitted to a steering wheel when the steering linkage is operated within the predetermined rotational range.

3. The steering linkage of claim 1 wherein the steering linkage is part of a steering system having a steering wheel and a steering gearbox and the steering linkage decouples the steering wheel from the steering gearbox when the steering linkage is operated within the predetermined rotational range.

4. The steering linkage of claim 3 wherein the steering system has a controller in communication with a steering angle sensor, the controller is programmed to actuate a motor to translate steering wheel angular movement to the gearbox requiring no direct mechanical link within the predetermined relative rotational range and the steering linkage provides a direct mechanical link when the predetermined relative rotational limit is met.

5. The steering linkage of claim 3 wherein the predetermined relative rotational range of the first steering shaft relative to the second steering shaft does not exceed 15 degrees.

6. The steering linkage of claim 1 further comprising the first steering shaft having a third interaction surface and the second steering shaft having a fourth interaction surface such that the first interaction surface contacts the second interaction surface at a positive direction relative rotational limit, and the third interaction surface contacts the fourth interaction surface at a negative direction relative rotational limit, the rotational distance between the positive and negative relative rotational limits being the predetermined relative rotational range.

7. The steering linkage of claim 6 wherein the predetermined relative rotational range of the first steering shaft relative to the second steering shaft is between 1 and 5 degrees.

8. A steer-by-wire system comprising:
a controller programmable to monitor motion of a steering wheel and to translate the motion of the steering wheel to a steering gearbox via a motor; and
a steering linkage disposed between two steering shafts providing decoupled rotation of the two shafts within a relative rotational range and coupled rotation of the two shafts at a relative rotational limit translating motion of the steering wheel to the steering gearbox.

9. The steer-by-wire system of claim 8 wherein the motor is an electric power assisted steering motor.

10. The steer-by-wire system of claim 8 wherein the relative rotational range is greater than 0 degrees and less than 15 degrees.

11. The steer-by-wire of claim 8 wherein the controller is programmable to provide variable ratio steering.

12. The steer-by-wire system of claim 8 wherein the steering linkage inhibits noise, vibration, and harshness transmissions from other components in the system to the steering wheel.

13. The steer-by-wire system of claim 8 further comprising a steering wheel movement motor in communication with the controller, and the controller being programmable to align steering wheel movement with steering gearbox movement using the steering wheel movement motor resulting from a vehicle wheel movement.

14. The steer-by-wire system of claim 13 wherein the controller is further programmed to filter out noise, vibration, and harshness from the gearbox and vehicle wheel from being transmitted to the steering wheel.

15. A semi-decoupled steering system comprising:
a controller programmable to monitor and align movement of a steering mechanism and a steering gearbox to provide a steer-by-wire effect; and
a passive mechanical linkage disposed between the steering mechanism and the steering gearbox to provide a direct mechanical link between the two when a misalignment limit of the two is met.

16. The steering system of claim 15 further comprising a first steering shaft in coupled movement with the steering mechanism, a second steering shaft in coupled movement with the steering gearbox, the misalignment limit being a relative rotational range of the two shafts of 15 degrees or less, and the passive mechanical linkage is disposed between and capable of coupling the two shafts at a rotational limit at one end of the relative rotational range.

17. The semi-decoupled steering system of claim 16 wherein the relative rotational range of the first and second shafts has a positive rotational direction limit and a negative rotational direction limit, and the first and second shafts are rotationally disengaged when relative rotation of the two shafts is between the limits, and rotationally engaged when the relative rotation of the two shafts meets one of the limits causing both shafts to rotate together until the relative rotation of the shafts changes direction to be within the relative rotational range causing the shafts to once again become disengaged and remaining disengaged until the positive rotational direction limit is re-met or the negative rotational direction limit is met in an opposite relative rotational direction of the shafts.

18. The semi-decoupled steering system of claim 17 wherein the steering mechanism and steering gearbox do not have a direct mechanical steering link when the mechanical linkage is operating within the relative rotational range inhibiting noise, vibration, and harshness from being transmitted from the steering gearbox to the steering mechanism.

19. The semi-decoupled steering system of claim 15 further comprising a steering gearbox motor configured to be actuated by the controller to align movement of the steering gearbox with the steering mechanism, and a steering mechanism motor configured to be actuated by the controller to align movement of the steering mechanism with the steering gearbox.

20. The semi-decoupled steering system of claim 15 wherein the passive mechanical linkage engages and translates the steering movement of the steering mechanism to the gearbox only when the miss-alignment limit is met.
